(19) United States
(12) Patent Application Publication
(10) Pub. No.: US 2005/0022608 A1
(43) Pub. Date: Feb. 3, 2005

(54) Apparatus for extruding a sample from a gyratory compactor mold and associated system and method

(75) Inventor: William M. Moscrip, Durham, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Troxler Electronic Laboratories, Inc.

(21) Appl. No.: 10/632,036

(22) Filed: Jul. 30, 2003

(51) Int. Cl. G01N 3/08

(52) U.S. Cl. 73/818

(57) ABSTRACT

4 An apparatus adapted to extrude a sample from a mold for a gyratory compactor is provided, the mold defining an interior portion and opposed open ends. A platform sealingly engages one of the opposed ends of the mold and defines a port extending to the interior portion of the mold when the mold is engaged therewith. A piston member is disposed in the interior of the mold between the sample and the platform, and is also movable with respect to the interior of the mold while forming a pressure seal therewith. A pressure source is operably engaged with the inlet port and is configured to exert a pressure through the inlet port and against the piston member so as to extrude the piston member and the sample from the mold through the other of the opposed ends of the mold. An associated system and method are also provided.

### BACKGROUND OF THE INVENTION

1. Field of the Invention

The present invention relates to an accessory for a gyratory compactor device and, more particularly, to an apparatus for extruding a sample from the mold of a gyratory compactor and associated system and method.

b 2. Description of Related Art

The Strategic Highway Research Program (SHRP), under the Federal Highway Administration (FHA), has developed a standard for testing the physical properties of a bituminous asphalt paving mix, otherwise known as hot mix asphalt (HMA), using a device known as the Superpave gyratory compactor. Several manufacturers produce gyratory compactors according to the Superpave gyratory compactor specifications. Gyratory compactors of this type are described for example in the following U.S. Pat. Nos. 5,323,655; 5,456,118; 5,606,133; 5,939,642; 5,817,946; and 6,026,692. Such a compactor simulates the kneading action of the large rollers used to compact asphalt pavement during highway construction. Thus, in turn, the compacted samples simulate the density, aggregate orientation, and structural characteristics obtained in an actual roadway when proper construction procedures are used in the placement of the paving mix. Accordingly, such samples may then be subjected to a variety of standardized test procedures to provide test results which may be useful, for example, in HMA mix design, in field control of an HMA production process, and in pavement layer design and/or performance prediction.

Typically, in preparing a compacted sample, a sample of the hot asphalt paving mix is placed in an open-ended cylindrical mold, with circular disks or plugs being placed at opposite ends of the mold. The gyratory compactor device applies pressure through these disks to the sample in the mold, along the longitudinal axis thereof, while simultaneously subjecting the sample to a rotating shear force by gyrating the mold about the longitudinal axis and at a specified tilt angle, but without rotating the mold about the longitudinal axis. Generally, the Superpave gyratory compactor specifications call for the mold to be gyrated at a compaction angle of 1.25 degrees and at 30 rpm, while applying a constant pressure of 600 kPa, typically for 100 gyrations. The gyratory compactor thus produces a gyratory kneading action that forms a tightly consolidated, generally cylindrical, HMA sample for subsequent determination of volumetric and mechanical properties. However, one of the results of the compaction process is that the compacted sample, and in some instances the disks used to compact the sample, may be difficult to remove from the mold and/or cannot be readily removed from the mold without damaging the sample.

Heretofore, processes for removing the compacted sample from the mold involved, for example, a hydraulic ram or a ball screw or other lead screw type mechanical assemblies for extruding the sample from the mold. However, such assemblies tended to be undesirably complex, large, and heavy, particularly in light of the development of bench-top size gyratory compactor devices. Further, such assemblies tended to require significant set up time and often provided a time-consuming extrusion process. Thus, there exists a need for a simpler, lighter, and more compact apparatus and associated method for providing faster and more efficient extrusion of a compacted sample from the mold of a gyratory compactor, as well as other improvements over existing devices.

### BRIEF SUMMARY OF THE INVENTION

The above and other needs are met by the present invention which, in one embodiment provides an apparatus adapted to extrude a sample from a mold for a gyratory compactor, wherein the mold defines an interior portion and opposed open ends. Such an apparatus comprises a platform configured to sealingly engage one of the opposed ends of the mold. The platform further defines a port extending to the interior portion of the mold when the mold is engaged therewith. A piston member is configured to be disposed in the interior of the mold between the sample and the platform. The piston member is also configured to be movable with respect to the interior of the mold while forming a pressure seal therewith. A pressure source is operably engaged with the inlet port and is configured to exert a pressure through the inlet port and against the piston member so as to extrude the piston member and the sample from the mold through the other of the opposed ends of the mold.

Another advantageous aspect of the present invention comprises a system adapted to produce a compacted paving mix sample. Such a system includes a gyratory compactor apparatus and an open-ended cylindrical mold having a wall defining an interior portion, wherein the mold is configured to be operably engageable with the gyratory compactor apparatus and is adapted to contain the paving mix sample therein for compaction by the gyratory compactor apparatus. An extrusion apparatus is operably engaged with the gyratory compactor apparatus and is configured to extrude the compacted paving mix sample from the mold. The extrusion apparatus further includes a platform configured to sealingly engage one of the open ends of the mold. The platform defines a port extending to the interior portion of the mold when the mold is engaged therewith. A piston member is configured to be disposed in the interior portion of the mold between the sample and the platform, and is further configured to be movable with respect to the interior portion of the mold while forming a pressure seal therewith. A pressure source is operably engaged with the inlet port and is configured to exert a pressure through the inlet port and against the piston member so as to extrude the piston member and the sample from the mold through the other of the open ends of the mold.

Still another advantageous embodiment of the present invention comprises a method for extruding a sample from a mold for a gyratory compactor, wherein the mold defines an interior portion and opposed open ends. A piston member is inserted into the interior of the mold, and is configured to be movable with respect to the interior of the mold while forming a pressure seal therewith. One of the opposed ends of the mold is then sealingly engaged with a platform such that the piston member is disposed between the sample and the platform. The platform further defines an inlet port extending to the interior of the mold when the mold is engaged therewith. A pressure is thereafter exerted through the inlet port and against the piston member, by a pressure source operably engaged with the inlet port, so as to extrude the piston member and the sample from the mold through the other of the opposed ends of the mold.

Thus, embodiments of the present invention provide significant advantages as described and as further detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic cross-sectional view of a gyratory compactor and a mold used thereby to produce a compacted sample;

FIG. 2 is a schematic cross-sectional view of a mold used by a gyratory compactor to produce a compacted sample;

FIG. 3 is a schematic exploded view of an apparatus for extruding a sample from a mold for a gyratory compactor, according to one embodiment of the present invention;

FIG. 4 is a schematic cross-sectional view of an apparatus for extruding a sample from a mold for a gyratory compactor, according to one embodiment of the present invention, illustrating a sample-containing mold engaged therewith;

FIG. 5 is a schematic cross-sectional view of an apparatus for extruding a sample from a mold for a gyratory compactor, according to one embodiment of the present invention, illustrating the sample being extruded from the mold; and

FIG. 6 is a schematic perspective view of an apparatus for extruding a sample from a mold for a gyratory compactor, according to one embodiment of the present invention, engaged with a gyratory compactor.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

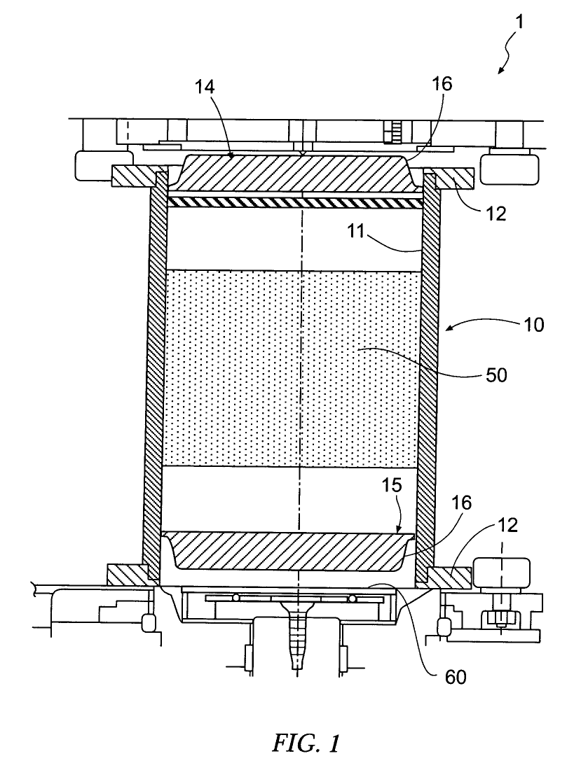

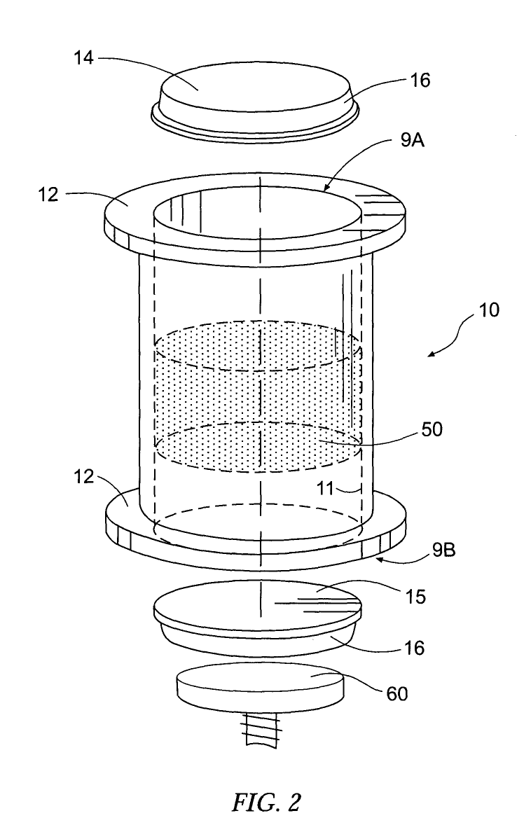

FIGS. 1 and 2 illustrate one example of a Superpave-type gyratory compactor 1 and mold 10 therefor capable of forming a compacted sample 50 of, for instance, an asphalt paving mix. More particularly, a cylindrical mold 10 is configured to form, in conjunction with the gyratory compactor 1, a compacted cylindrical test sample 50 from a selected amount of the asphalt paving mix. The mold 10 includes a cylindrical side wall 11 which is of a substantially uniform inner diameter and has open opposite ends 9A, 9B. The particular mold 10 illustrated in FIG. 2 has out-turned flanges 12 adjacent to the upper and lower ends 9A, 9B of the cylindrical side wall 11 which provide engagement surfaces cooperating with components of one particular design of a commercially available gyratory compactor apparatus 1 so that the gyratory compactor apparatus 1 can hold the mold 10 and impart a gyratory motion thereto. However, some gyratory compactor designs do not require a flanged mold 10. Therefore, it should be clearly understood that the flanges 12 shown in FIG. 2 are not an essential to the present invention, and the present invention can be operated with other mold designs, including those having a single flange or having no flange, or having other auxiliary elements provided on the mold for cooperating with a particular design of gyratory compactor.

During the compaction process, as shown in FIG. 1, the sample 50 is contained in the mold 10 between removable disk-shaped plates 14, 15, otherwise referred to as “disks” or “pucks,” so that pressure can be applied to the sample 50 of asphalt paving mix within the mold 10. More particularly, a compaction ram 60 is urged into the mold 10 along the longitudinal axis thereof, while the sample is simultaneously subjected to a rotating shear force resulting from the gyration of the mold 10 about the longitudinal axis with a specified tilt angle or angle of gyration, and without rotation of the mold 10 with respect to the axis. Certain of the commercially available gyratory compactor designs employ two separate and independent plates 14, 15 which are not physically connected to any part of the gyratory compactor apparatus, and this is the design shown in the accompanying drawings. In other designs (not shown) the end of the compaction ram 60 of the compactor functions as one of the disk-shaped plates 14, 15. However, embodiments of the present invention are applicable to both of these variations.

As further shown in FIGS. 1 and 2, the plates 14, 15 have an outer diameter corresponding substantially to the inner diameter of the mold 10 so as to fit loosely within the mold 10 without binding. Preferably, the plates 14, 15 have a tapered outer wall 16 to accommodate the tilting and gyrating movement of the mold 10. Typically, during normal use, when the gyratory compactor apparatus 1 is used for producing a test sample, one plate 15 is placed within the mold 10 to block one of the ends 9A, 9B thereof and then a measured sample of the asphalt paving mix is introduced into the mold 10. The opposite end of the mold 10 is closed by placing the second plate 14 within the mold 10, and then the assembly is placed within a gyratory compactor apparatus 1. Once placed into the compactor apparatus, the plate 14 at one end of the mold 10 is supported or restrained, while the pressure ram 60 is moved into position bearing against the opposite plate 15 to apply a compaction pressure to the sample within the mold 10. As the pressure is being applied, the mold 10 is gyrated about an angle of gyration, in accordance with well-known techniques, for example, as disclosed in the aforementioned patents. For those designs of gyratory compactors which use only a single plate, rather than a pair of plates, the mold is positioned in the gyratory compactor and either the pressure ram itself, or else a plate carried by the ram, is brought into position for applying pressure to the sample. Accordingly, the Superpave gyratory compactor specifications call for the mold 10 to be gyrated at a specified angle, at a specified rpm, and while applying a specified constant pressure, so as to produce a compacted sample 50.

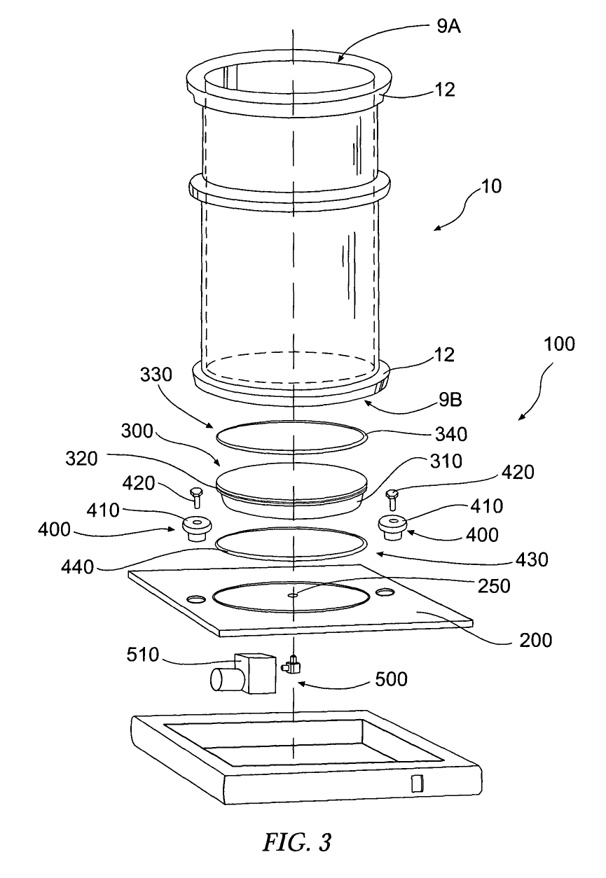

Once the sample 50 is compacted by the gyratory compactor 1, the mold 10 is removed from the gyratory compactor 1. In some instances, one or both plates 14, 15 may not be readily removable from the mold 10 due to, for example, adherence to the compacted sample 50 or tight tolerances between the respective plate and the wall 11 of the mold 10. Typically, the sample 50 is also not readily removable from the mold 10. Accordingly, FIG. 3 illustrates one embodiment of an apparatus for extruding the sample 50 from the mold 10, the apparatus being indicated generally by the numeral 100. Such an apparatus 100 comprises, for example, a platform 200 defining at least one inlet port 250, a piston member 300, at least one securing device 400, and a pressure source 500.

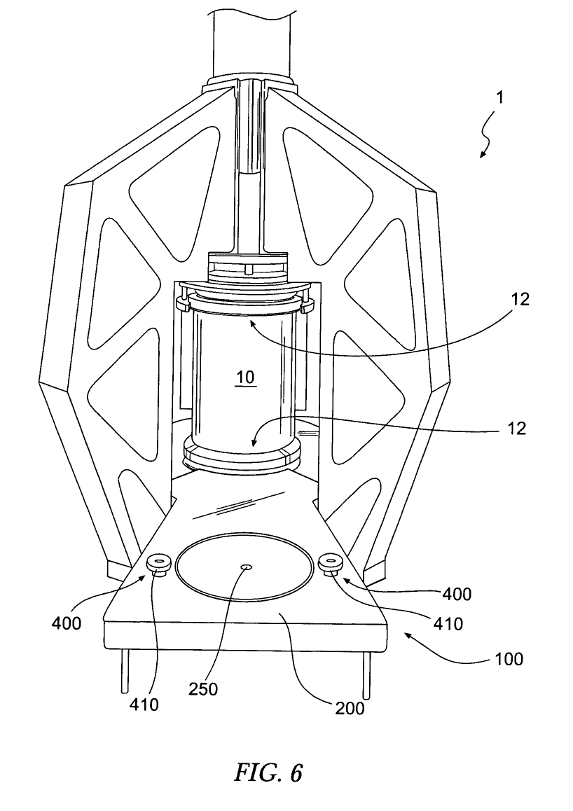

The apparatus 100 may be free standing or, in some instances, may be engaged with, integrated with, or otherwise co-operable with any one of a number of different types of gyratory compactors, the gyratory compactor 1 shown in FIGS. 1 and 2 being but one example, such that the mold 10 containing the sample 50 may be removed from the gyratory compactor 1 and easily and readily transferred to the extrusion apparatus 100. One example of such a combination is shown in FIG. 6. Further, one skilled in the art will appreciate that the extrusion apparatus 100 may be combined with or integrated with a gyratory compactor 1 in many different manners such as, for example, by providing a track, conveyor, or other pathway configured to be manually used by an operator, or by using an automated robot or other mechanism, to transfer the mold 10 between the compactor 1 and the extrusion apparatus 100. In some instances, the extrusion apparatus 100 may be incorporated into the gyratory compactor 1 such that the mold 10 does not have to be removed therefrom in order for the extrusion apparatus 100 to extrude the sample 50 from the mold 10. Thus, the examples presented herein for combining a gyratory compactor 1 with an extrusion apparatus 100 are not intended to be limiting.

As shown in FIG. 3, the piston member 300 is first inserted into one of the ends 9A, 9B of the mold 10, adjacent to the sample 50, or one of the plates 14, 15 if remaining in the mold 10. The piston member 300 is preferably disk-shaped and is configured to be inserted into the interior portion of the mold 10. Further, the piston member 300 defines a perimeter 310, wherein the perimeter 310 defines a groove 320 configured to accept a sealing member 330 such as, for example, an O-ring 340. The O-ring 340 is configured to extend radially outward of the perimeter 310 of the piston member 300. Accordingly, when the piston member 300 is inserted into the interior portion of the mold 10, the O-ring 340 forms a pressure seal with the interior wall 11, but allows the piston member 300 to be axially movable along the mold 10. However, one skilled in the art will appreciate that other configurations of sealing members 330 can also be implemented. For example, a sealing member 330 could be provided in disk-shaped form for securing to one of the axial faces of the piston member 300 or for securing between two axially separable portions of the piston member 300. In some instances, multiple sealing members 330 may also be used. In any instance, it is preferable for the piston member 300 to form a pressure seal with the interior wall 11 of the mold 10, while the piston member 300 remains axially movable within the mold 10. One skilled in the art will also appreciate that piston member 300 sealing member 330 are provided herein as part of the apparatus 100 due to, for example, porosity of the HMA sample 50 or to minimize the risk of damage to the sample 50. However, the piston member 300/sealing member 330 may not be necessary in some instances where, for example, the characteristics of the sample 50 may be such that a pressure seal, as described further herein, can be sufficiently formed by the sample 50 itself or the risk of damage to the sample 50 is not a major concern.

Once the piston member 300 is inserted into the mold 10, the end of the mold 10 through which the piston member 300 is inserted in engaged with the platform 200 and secured thereto with one or more securing devices 400. The one or more securing devices 400 may be provided in many different forms depending on, for example, the type or manufacturer of the mold 10, the configuration of the mold 10, or the nature and configuration of the flanges, if any, of the mold 10. In the configuration shown, two securing devices 400, comprising diametrically-opposed clamp members 410 configured to extend over or otherwise engage a flange 12 of the mold 10, extend between the mold 10/flange 12 and the platform 200 and are removably secured to the platform 200 with respective fasteners 420. Further, in some instances, a sealing member 430, such as an O-ring 440, may be disposed between the mold 10/flange 12 and the platform 200 so as to provide a pressure seal therebetween. In any instance, it is preferable for the mold 10/flange 12 to form a pressure seal with the platform 200 when secured thereto. As such, one skilled in the art will appreciate that such a pressure seal may be accomplished in different manners. For example, the mold 10/flange 12 and/or the platform 200 may define a groove (not shown) configured to receive and properly locate the O-ring 440. Accordingly, when the mold 10 is secured to the platform 200, a substantially pressure-tight chamber 600 is formed by the piston member 300, the platform 200, and the wall 11 of the mold 10 disposed therebetween.

The platform 200 further defines at least one inlet port 250 that extends therethrough and to the chamber 600 when the mold 10 is secured to the platform 200. A pressure source 500 is connected to the inlet port 250 in such a manner as to be capable of pressurizing the chamber 600. In one embodiment, the pressure source 500 may comprise, for instance, an electrically-operated air pump 510 configured to pump air into the chamber 600 to provide the necessary pressure in the chamber 600, as well as, for example, to provide the desired extrusion characteristics. That is, for instance, the air pump 510 may be configured to provide a selected maximum pressure and/or flow rate of the air pumped into the chamber 600 sufficient to extrude the sample 50 from the mold 10 within an acceptable period of time. More particularly, the rate of extrusion may be controlled without the use of sensors, limit switches, or the like by a combination of the selected air flow rate and the maximum pressure attained by the air pump 510.

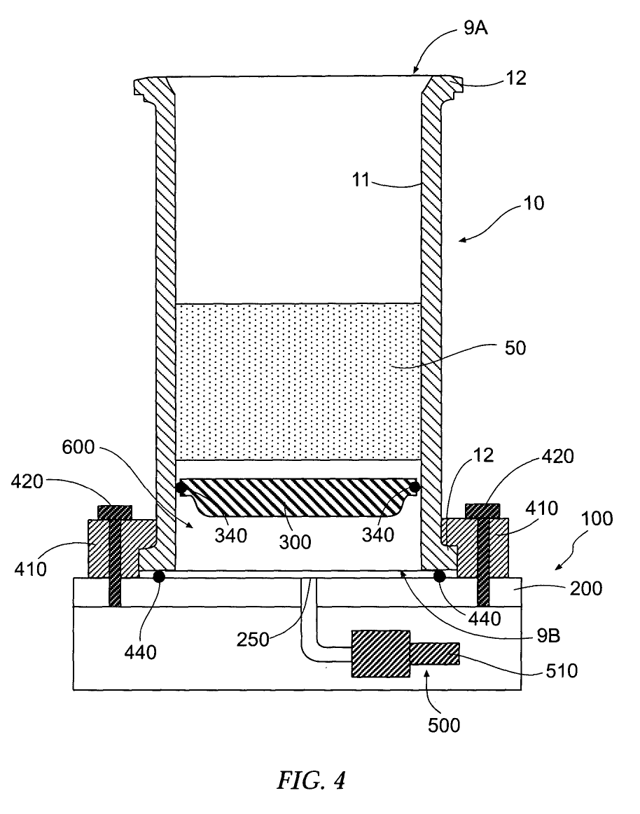

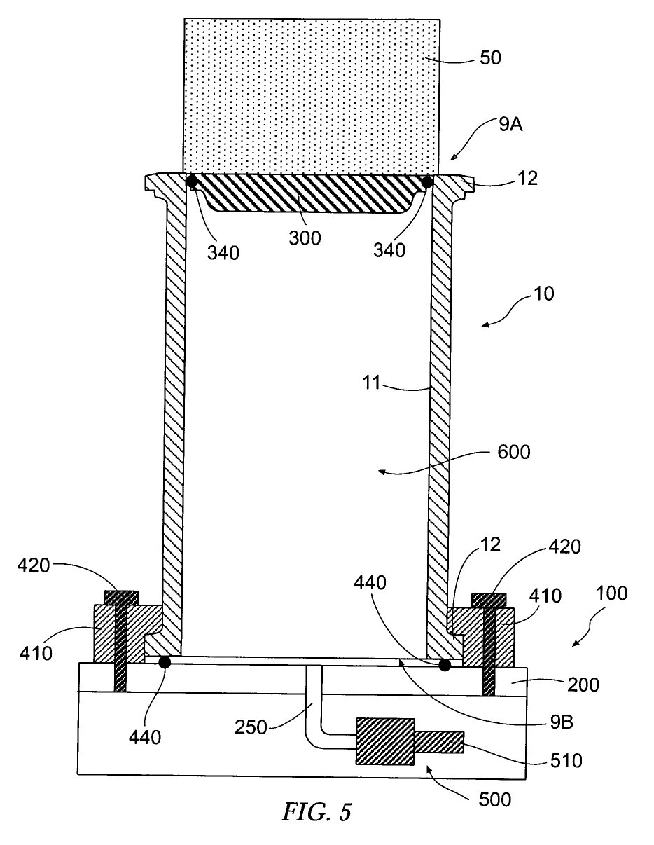

Accordingly, the air flow rate and maximum pressure are selected such that, upon initial actuation of the air pump 510, the air is pumped into a relatively small volume chamber 600, as shown in FIG. 4. The pressure within the chamber 600 and against the piston member 300 thus rises relatively quickly until a maximum pressure is attained that is sufficient to shear the adhesion forces holding the sample 50 against the mold wall 11. Continued air flow from the air pump 510 thereafter causes the piston member 300 and the sample 50 to move toward the opposite end of the mold 10 at a sufficient extrusion rate, thereby resulting in an increase of the volume of the chamber 600. The piston member 300 eventually reaches a point along the mold 10, as shown in FIG. 5, where the sealing member 330 no longer forms a pressure seal with the mold wall 11, and the air pressure built up within the chamber 600, as well as the air flow continually fed into the chamber 600 by the air pump 510, thereafter vent through any radial gap between the sealing member 330 and the mold wall 11. In one instance, the continued air flow provided by the air pump 510 and/or the sealing member 330 engaged with the piston member 300 may thereafter support the piston member 300 and the sample 50 at the extrusion end of the mold 10, where it can then be removed, for example, by an operator or by an automated device (not shown). In other instances, the piston member 300 may at least partially retract into mold 10, leaving the sample 50 supported by the continued air flow from the air pump 510 and/or the extrusion end of the mold 10. More particularly, an HMA sample 50 has a low bulk modulus and thus tends to expand once extruded from the mold 10. Thus, once the sample 50 expands following extrusion, it may not be able to reenter the mold 10, whereas the more dimensionally stable piston member 300 may be able to at least partially retract into the mold 10, thereby leaving the sample 50 to be supported at the extrusion end of the mold 10.

Embodiments of the present invention thus provide an apparatus and associated method capable of extruding a compacted sample of an asphalt paving mix from the mold of a gyratory compactor. Such a pneumatic apparatus is less complex, smaller in size and weight, less costly, and more efficient and controllable than heretofore utilized hydraulic or lead screw type mechanical assemblies. For example, the pneumatic extrusion apparatus as disclosed herein does not require either the mechanical linkage and/or ram arm of previous hydraulic assemblies or heavy components of lead screw type assemblies. Also, only relatively simple securing devices are required to secure the mold to the extrusion apparatus, and no sensors, limit switches, or the like are required to control the pneumatic extrusion apparatus. Further, such an apparatus is scalable so as to provide a bench-top sized device that may be provided as a stand-alone unit or integrated with or otherwise engaged with a gyratory compactor, thereby providing a more compact system.

As an example of the foregoing disclosure, a representative mold 10 for a gyratory compactor 1 may have an inner diameter of about 150 mm (5.91 in.), and be about 10-13 in. long. A representative compacted sample 50 of an asphalt paving mix, compacted within the mold 10, may have a compacted length of about 115 mm (4.53 in.) and weigh about 4-5 kg (8.82-11.02 lbs.). The piston member 300 may be made of, for example, steel, and weigh about 2.4 kg (5.34 lbs.). With such a configuration, an extrusion apparatus 100 according to one embodiment of the present invention is generally required to produce a pressure of about 2-3 psi within the chamber 600 in order to shear the adhesive forces holding the sample 50 within the mold 10 and to begin extrusion of the sample 50 from the mold 10. The air pump 510, in such an instance, may be sized to deliver a flow rate of about 12-13 liters per minute to the chamber. Accordingly, since the volume of the mold 10 in this example is about 5.8 liters, it will take slightly less than about 30 seconds for the sample 50 to be extruded from the mold 10. One skilled in the art will appreciate, however, that this example is merely for illustrative purposes and is not intended to be limiting or restricting in any manner with respect to the various parameters which may be implemented in an apparatus, system, or method according to any embodiment of the present invention.

Many modifications and other embodiments of the inventions set forth herein will come to mind to one skilled in the art to which these inventions pertain having the benefit of the teachings presented in the foregoing descriptions and the associated drawings. For example, the pressure source 500 may comprise other sources, such as shop air, which will be appreciated by one skilled in the art as capable of being provided by any number of pumps such as diaphragm pumps, free-piston pumps, scroll pumps, gear driven pumps, or the like. In other instances, other gases such as carbon dioxide or tetrafluoroethane or the like may be the pressure source 500 as provided by a bottled gas source or in another appropriate manner. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus adapted to extrude a sample from a mold for a gyratory compactor, the mold defining an interior portion and opposed open ends, said apparatus comprising:
a platform configured to sealingly engage one of the opposed ends of the mold, the platform defining a port extending to the interior portion of the mold when the mold is engaged therewith;
a piston member configured to be disposed in the interior portion of the mold between the sample and the platform, the piston member being further configured to be movable with respect to the interior portion of the mold while forming a pressure seal therewith; and
a pressure source operably engaged with the inlet port and configured to exert a pressure through the inlet port and against the piston member so as to extrude the piston member and the sample from the mold through the other of the opposed ends of the mold.

2. An apparatus according to claim 1 wherein the piston member defines a perimeter and the apparatus further comprises an O-ring disposed about the perimeter of the piston member, the O-ring being configured to engage a wall defining the interior portion of the mold so as to allow the piston member to form a pressure seal therewith while also allowing the piston member to be movable with respect thereto.

3. An apparatus according to claim 1 further comprising an O-ring operably engaged with the one end of the mold so as to be disposed between the mold and the platform and to form a pressure seal therebetween when the mold is engaged with the platform.

4. An apparatus according to claim 1 further comprising at least one securing device configured to be operably engageable between the platform and the mold so as to secure the mold to the platform as the sample is extruded.

5. An apparatus according to claim 1 wherein the pressure source further comprises an air pump configured to pump air at a selected substantially constant flow rate through the inlet port to the interior portion of the mold.

6. An apparatus according to claim 5 wherein the air pump is further configured to have a selected maximum pressure output.

7. A system adapted to produce a compacted paving mix sample, said system comprising:
a gyratory compactor apparatus;
an open-ended cylindrical mold having a wall defining an interior portion, the mold being configured to be operably engageable with the gyratory compactor apparatus and adapted to contain the paving mix sample therein for compaction by the gyratory compactor apparatus; and
an extrusion apparatus operably engaged with the gyratory compactor apparatus and configured to extrude the compacted paving mix sample from the mold, the extrusion apparatus comprising:
a platform configured to sealingly engage one of the open ends of the mold, the platform defining a port extending to the interior portion of the mold when the mold is engaged therewith;
a piston member configured to be disposed in the interior portion of the mold between the sample and the platform, the piston member being further configured to be movable with respect to the interior portion of the mold while forming a pressure seal therewith; and
a pressure source operably engaged with the inlet port and configured to exert a pressure through the inlet port and against the piston member so as to extrude the piston member and the sample from the mold through the other of the open ends of the mold.

8. A system according to claim 7 wherein the piston member defines a perimeter and the extrusion apparatus further comprises an O-ring disposed about the perimeter of the piston member, the O-ring being configured to engage the wall defining the interior of the mold so as to allow the piston member to form a pressure seal therewith while also allowing the piston member to be movable with respect thereto.

9. An apparatus according to claim 7 further comprising an O-ring operably engaged with the one open end of the mold so as to be disposed between the mold and the platform and to form a pressure seal therebetween when the mold is engaged with the platform.

10. An apparatus according to claim 7 further comprising at least one securing device configured to be operably engageable between the platform and the mold so as to secure the mold to the platform as the sample is extruded.

11. An apparatus according to claim 7 wherein the pressure source further comprises an air pump configured to pump air at a selected substantially constant flow rate through the inlet port to the interior portion of the mold.

12. An apparatus according to claim 11 wherein the air pump is further configured to have a selected maximum pressure output.

13. A method for extruding a sample from a mold for a gyratory compactor, the mold defining an interior portion and opposed open ends, said method comprising:
inserting a piston member into the interior portion of the mold, the piston member being configured to be movable with respect to the interior portion of the mold while forming a pressure seal therewith;
sealingly engaging one of the opposed ends of the mold with a platform such that the piston member is disposed between the sample and the platform, the platform defining an inlet port extending to the interior portion of the mold when the mold is engaged therewith; and
exerting a pressure through the inlet port and against the piston member with a pressure source operably engaged with the inlet port so as to extrude the piston member and the sample from the mold through the other of the opposed ends of the mold.

14. A method according to claim 13 further comprising operably engaging an O-ring with the piston member about a perimeter thereof, such that, when the piston member is inserted into the interior portion of the mold, the O-ring engages a wall defining the interior portion of the mold and forms a pressure seal therewith while allowing the piston member to be movable with respect thereto.

15. A method according to claim 13 wherein sealingly engaging one of the opposed ends of the mold with the platform further comprises operably engaging an O-ring between the one end of the mold and the platform so as to form a pressure seal therebetween when the mold is engaged with the platform.

16. A method according to claim 13 further comprising operably engaging at least one securing device between the platform and the mold so as to secure the mold to the platform as the sample is extruded.

17. A method according to claim 13 wherein exerting a pressure through the inlet port further comprises pumping air at a selected substantially constant flow rate, with an air pump, through the inlet port to the interior portion of the mold.

18. A method according to claim 17 wherein pumping air further comprises pumping air with an air pump configured to have a selected maximum pressure output.
